(19) United States
(12) Patent Application Publication
(10) Pub. No.: US 2014/0158815 A1
(43) Pub. Date: Jun. 12, 2014

(54) Zero Transition Vertical Take-Off and Landing Aircraft

(71) Applicant: Joseph Raymond RENTERIA, Beaumont, CA (US)

(72) Inventor: Joseph Raymond RENTERIA, Beaumont, CA (US)

(21) Appl. No.: 13/903,471

(22) Filed: May 28, 2013

Related U.S. Application Data
(60) Provisional application No. 61/735,450, filed on Dec. 10, 2012.

(51) Int. Cl. B64C 29/00

(52) U.S. Cl. CPC B64C 29/00
USPC 244/12.1

(57) ABSTRACT

A zero transition vertical take-off and landing (VTOL) aircraft, which is stable in all levels of flight, especially the transition phase from vertical to horizontal flight. The zero transition VTOL aircraft is capable of achieving both vertical and horizontal flight without changing the positioning of thrusters, such as through the use of tiltable or rotatable nacelles or wings. Rather a front thruster assembly and a rear thruster assembly are positioned at specific angles in relation to each other along at least one fuselage in order to generate the desired ratio of vertical to horizontal thrust. At least one wing is also positioned at a specific wing angle in order to achieve a desired angle of attack when in horizontal flight. The attitude of the zero transition VTOL aircraft can be controlled through the use of differential thrust alone, or in conjunction with control surfaces.

The current application claims a priority to the U.S. Provisional Patent application Ser. No. 61/735,450 filed on Dec. 10, 2012.

### FIELD OF THE INVENTION

The present invention relates generally to an aircraft and propulsion system. More specifically, the propulsion system allows the aircraft to take-off and land horizontally or vertically. Furthermore, there is no transition phase of moving components as the aircraft shifts from vertical to horizontal flight.

### BACKGROUND OF THE INVENTION

In the world of aviation there are many different types of aircraft that are each designed with specific traits for different types of missions. Planes offer a longer range of flight as well as greater flight speeds, while helicopters allow for vertical take-off and landing as well as provide hovering capabilities. As such, it has become desirable to combine the benefits of both airplanes and helicopters into one aircraft. Thus, airplanes capable of vertical take-off and landing have become an increasingly popular aircraft design as they offer the versatility of being used in several different types of aircraft missions. However, there are flaws in the design of many of these types of aircraft. For one, many of the vertical take-off and landing aircraft feature tilting rotors or other movable parts. As the aircraft ascends, the thrusters rotate or move from a vertical position to a horizontal position. Any malfunctions of rotating parts in this transition state can cause the system to fail. In turn, system failure can cause the airplane to stall or, worse, crash. Secondly, most vertical take-off and landing aircraft are very vulnerable in the transition state from vertical to horizontal flight. Often times this transition state features a window of low stability where the aircraft is especially vulnerable to strong gusts of wind, pilot error, etc.

Therefore it is the object of the present invention to provide an aircraft capable of vertical take-off and landing that is stable in all levels of flight. Additionally, the aircraft can achieve vertical take-off and landing without any rotating or moving thrusters or wing parts. The aircraft features a unique design in which forward and rear thrusters are mounted at angles to optimize both vertical and forward flight. Furthermore, the aircraft can be flown using differential thrust alone or with the additional use of control surfaces.

### BRIEF DESCRIPTION OF THE DRAWINGS

FIG. 1 is a perspective view of the zero transition VTOL aircraft in the preferred embodiment of the present invention.

FIG. 2 is a left side elevational view of the zero transition VTOL aircraft in the preferred embodiment of the present invention.

FIG. 3 is a front elevational view of the zero transition VTOL aircraft in the preferred embodiment of the present invention.

FIG. 4 is a top elevational view of the zero transition VTOL aircraft in the preferred embodiment of the present invention.

FIG. 5 is a perspective view of the center of gravity, longitudinal axis and lateral axis of the zero transition VTOL aircraft.

FIG. 6 is a top elevational view of the center of gravity, longitudinal axis and lateral axis of the zero transition VTOL aircraft.

FIG. 7 is a perspective view of the intersection of the wing chord plane and first plane along the wing intersection axis.

FIG. 8 is a perspective view of the intersection of the wing chord plane and rear thruster plane along the rear intersection axis.

FIG. 9 is a perspective view of the intersection of the rear thruster plane and front thruster plane along the front intersection axis.

FIG. 10 is a left side view of the wing angle, front thruster angle, and rear thruster angle.

FIG. 11 is a left side view depicting the positioning of the front thruster assembly normal to the front thruster plane and the rear thruster assembly normal to the rear thruster plane.

FIG. 12 is a perspective view depicting the front thruster assembly positioned across the front thruster plane and the rear thruster assembly positioned across the rear thruster plane.

FIG. 13 is a front view depicting the front thruster assembly and the rear thruster assembly positioned laterally about the center of gravity.

FIG. 14 is a left side sectional view of the at least one front thruster positioned within the at least one front nacelle.

FIG. 15 is a left side sectional view of the at least one rear thruster positioned within the at least one rear nacelle.

FIG. 16 is a diagram depicting the typical thrust produced while taking off vertically and transitioning into forward flight.

FIG. 17 is a perspective view of the zero transition VTOL aircraft having the at least one empennage connected to the at least one wing.

### DETAIL DESCRIPTIONS OF THE INVENTION

All illustrations of the drawings are for the purpose of describing selected versions of the present invention and are not intended to limit the scope of the present invention.

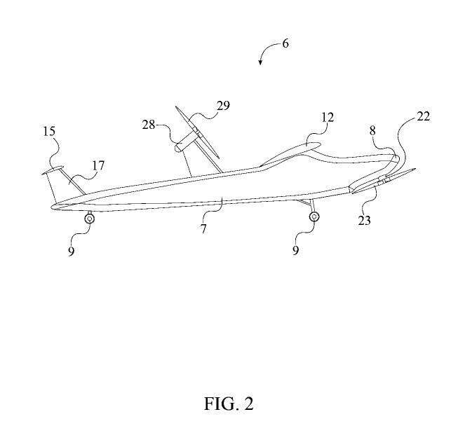

The present invention is a zero transition vertical take-off and landing (VTOL) aircraft, which is stable in all levels of flight. Zero transition meaning there is no transition state between vertical and forward flight in which the present invention is unstable. In reference to the direction of angles hereinafter described, a positive angle is defined as an angle traversing in a counterclockwise direction when the zero transition VTOL aircraft is oriented as shown in FIG. 2. A negative angle is defined as an angle traversing in a clockwise direction when the zero transition VTOL aircraft is oriented as shown in FIG. 2.

The zero transition VTOL aircraft comprises an airframe 6, a front thruster assembly 18, and a rear thruster assembly 24. In the preferred embodiment of the present invention, the front thruster assembly 18 and the rear thruster assembly 24 are mounted to the airframe 6 at a fixed angle such that the zero transition VTOL aircraft may achieve both horizontal and vertical flight. The airframe 6 comprises an at least one fuselage 7, an at least one wing 12, and an at least one empennage 14. The at least one fuselage 7 provides a central body of which can be used to provide a cockpit and/or a cargo bay. Each of the at least one fuselage 7 comprises a nose cone 8 and a landing gear assembly 9. The nose cone 8 provides an aerodynamic surface for the front of the zero transition VTOL aircraft, while the landing gear assembly 9 allows the zero transition VTOL aircraft to take-off and land horizontally, as well as taxi on a runway. The at least one wing 12 provides a lift generating surface for the zero transition VTOL aircraft, while the at least one empennage 14 provides stabilizing surfaces and comprises an at least one horizontal stabilizer 15 and in some embodiments an at least one vertical stabilizer 17.

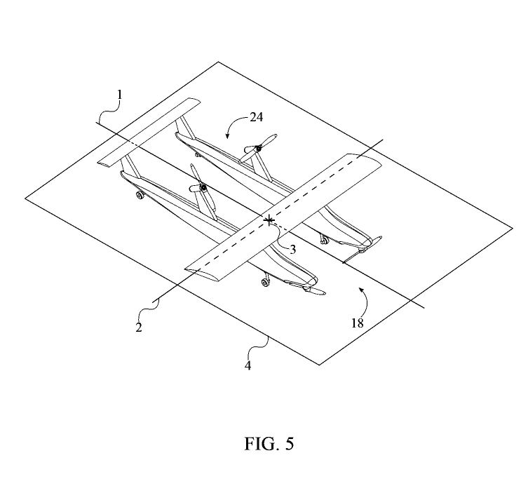

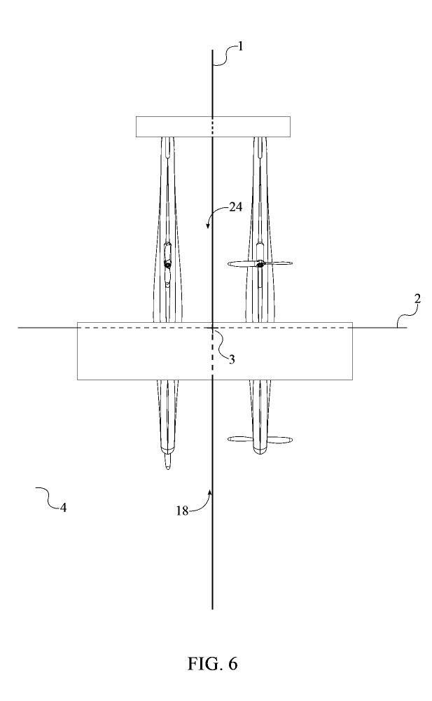

In reference to FIG. 5-6, a center of gravity 3 is determined by the positioning of the components of the airframe 6, front thruster assembly 18, and the rear thruster assembly 24 and the overall mass of the zero transition VTOL aircraft. The center of gravity 3 provides a reference point through which a longitudinal axis 1 and a lateral axis 2 traverse. The longitudinal axis 1 is the axis about which the zero transition VTOL aircraft rolls, while the lateral axis 2 is the axis about which the zero transition VTOL aircraft pitches. As such, the lateral axis 2 is perpendicular to the longitudinal axis 1. A first plane 4 is coincident with both the longitudinal axis 1 and the lateral axis 2, creating a lengthwise intersection of the zero transition VTOL aircraft.

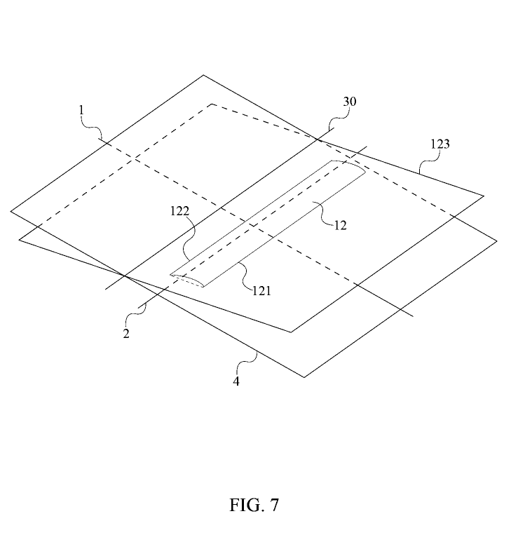

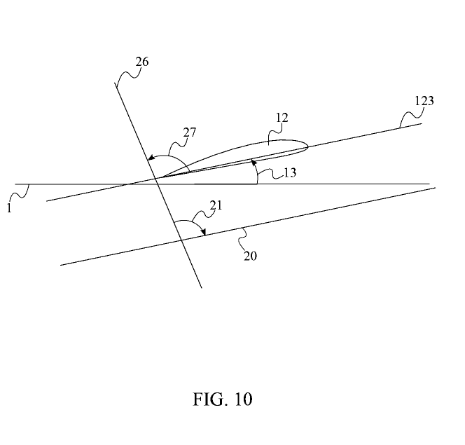

In reference to FIG. 7 and FIG. 10, the positioning of the at least one wing 12 is first determined in order to achieve a desired angle of attack when the zero transition VTOL aircraft is in horizontal flight. Additionally, the at least one wing 12 is ideally positioned such that it provides a lift force at or near the center of gravity 3 when the zero transition VTOL aircraft is in forward flight. Each of the at least one wing 12 comprises a leading wing edge 121 and a trailing wing edge 122. The leading wing edge 121 and the trailing wing edge 122 are positioned opposite of each other across the at least one wing 12. The leading wing edge 121 is the foremost edge of the at least one wing 12 and is where the airflow separates around the at least one wing 12. The trailing wing edge 122 is the rearmost edge of the at least one wing 12 and is where the airflow separated around the at least one wing 12 rejoins. A wing chord plane 123 is coincident with both the leading wing edge 121 and the trailing wing edge 122. In this way, the chord line of the at least one wing 12 is positioned on the wing chord plane 123. The wing chord plane 123 is coincident with the first plane 4 along a wing intersection axis 30. The wing intersection axis 30 is parallel to the lateral axis 2 and provides an axis about which the wing chord plane 123 may pivot. The wing chord plane 123 is positioned at a wing angle 13 in relation to the first plane 4. The wing angle 13 determines the angle of attack of the at least one wing 12 when the zero transition VTOL aircraft is in horizontal flight. The wing angle 13 traverses from the first plane 4 to the wing chord plane 123 and is a positive angle between 0 degrees and 45 degrees.

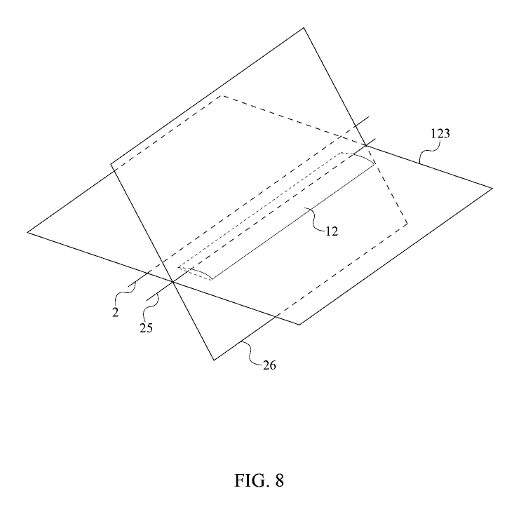

In reference to FIG. 8, the positioning of the rear thruster assembly 24 is then determined in relation to the at least one wing 12. A rear thruster plane 26 is coincident with the wing chord plane 123 along a rear intersection axis 25. The rear intersection axis 25 is parallel to the lateral axis 2. The rear intersection axis 25 provides an axis about which the rear thruster plane 26 may pivot in relation to the wing chord plane 123.

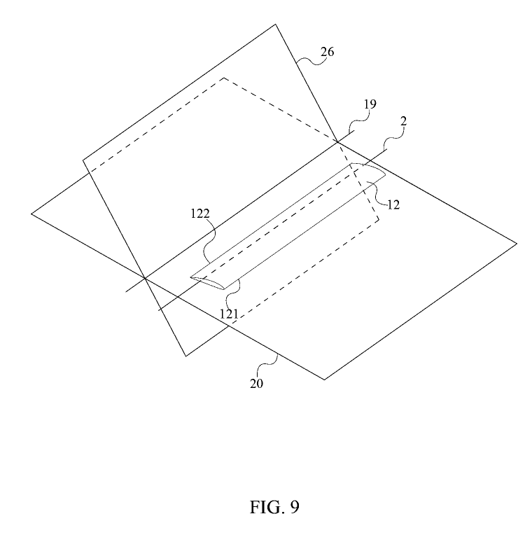

In reference to FIG. 9, the positioning of the front thruster assembly 18 is then determined in relation to the rear thruster plane 26. A front thruster plane 20 is coincident with the rear thruster plane 26 along a front intersection axis 19. The front intersection axis 19 is parallel to the lateral axis 2. The front intersection axis 19 provides an axis about which the front thruster plane 20 may pivot in relation to the rear thruster plane 26.

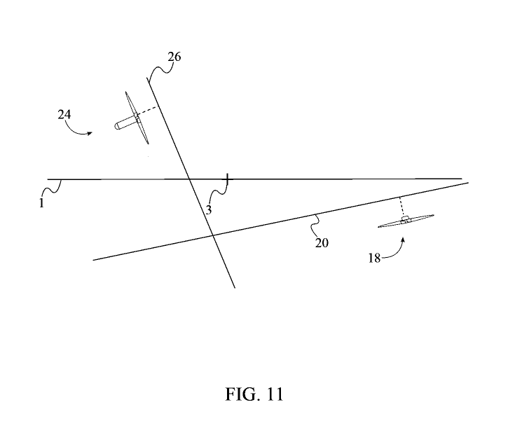

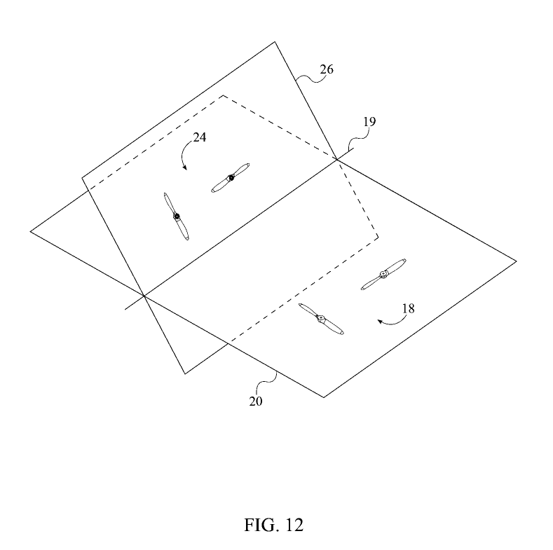

In reference to FIG. 10-12, the rear thruster plane 26 is positioned at a rear thruster angle 27 in relation to the wing chord plane 123. The rear thruster angle 27 traverses from the wing chord plane 123 to the rear thruster plane 26 and is a positive angle between 80 degrees and 130 degrees. The rear thruster assembly 24 is positioned normal to the rear thruster plane 26 such that the thrust produced is directed both horizontally backwards and vertically downwards. The value of the rear thruster angle 27 can be determined as to provide the desired ratio of horizontal thrust to vertical thrust. The front thruster plane 20 is positioned at a front thruster angle 21 in relation to the rear thruster plane 26. The front thruster angle traverses from the rear thruster plane 26 to the front thruster plane 20 and is a negative angle between 90 degrees and 150 degrees. The front thruster assembly 18 is positioned normal to the front thruster plane 20 such that the thrust produced is directed both horizontally forwards and vertically downwards. The value of the front thruster angle 21 can be determined as to provide the desired ratio of horizontal thrust to vertical thrust. By altering the value of the front thruster angle 21 and/or the rear thruster angle 27, the zero transition VTOL aircraft can be optimized for horizontal or vertical flight depending on the intended mission of the zero transition VTOL aircraft.

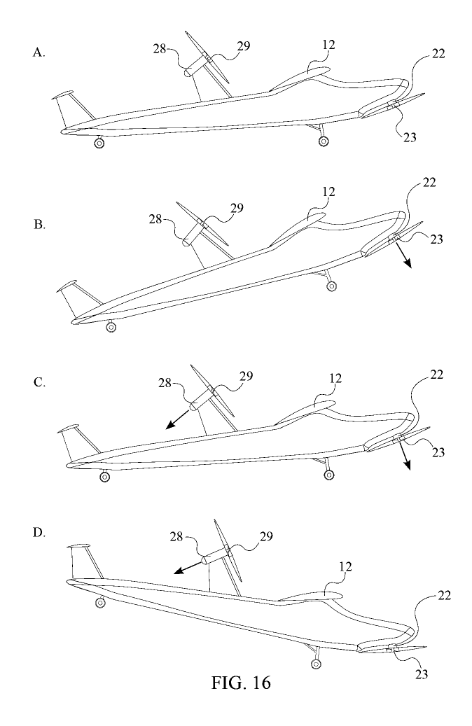

In reference to FIG. 16, the zero transition VTOL aircraft can move from vertical to forward flight by altering the thrust produced by both the front thruster assembly 18 and the rear thruster assembly 24. In part A of FIG. 16, the zero transition VTOL is at rest and neither the front thruster assembly 18 nor the rear thruster assembly 24 is producing thrust. In order to achieve vertical flight, power is first supplied to the front thruster assembly 18, which in turn causes the frontward section of the zero transition VTOL aircraft to lift off of the ground, as shown in part B of FIG. 16. Power is then supplied to the rear thruster assembly 24, causing the rearward section of the zero transition VTOL aircraft to lift-off, as shown in part C of FIG. 16. The horizontal thrust produced by the front thruster assembly 18 negates the horizontal thrust produced by the rear thruster assembly 24, allowing the zero transition VTOL aircraft to perform a stable vertical take-off. During vertical take-off, the nose cone 8 is directed upwards. The zero transition VTOL aircraft is also capable of maintaining stable hover in the nose cone 8 up position. Ideally, the front thruster assembly 18 and the rear thruster assembly 24 equally support the weight of the zero transition VTOL aircraft when it is in a hover position. The zero transition VTOL aircraft can also be directed into the wind while taking off and hovering in order to generate a lift force from the at least one wing 12. This lift force assists the front thruster assembly 18 and rear thruster assembly 24 in supporting the zero transition VTOL aircraft while in lift off or hover and thus reduces the power consumption of the front thruster assembly 18 and rear thruster assembly 24.

In reference to part D of FIG. 16, once the zero transition VTOL aircraft has achieved vertical take-off, horizontal flight can be achieved by adjusting the power supplied to the front thruster assembly 18 and the rear thruster assembly 24. The power supplied to the rear thruster assembly 24 is increased and/or the power supplied to the front thruster assembly 18 is reduced. In turn, the horizontal thrust produced by the rear thruster assembly 24 overcomes the horizontal thrust produced by the front thruster assembly 18, allowing forward flight of the zero transition VTOL aircraft. It may also be possible to completely impede power to the front thruster assembly 18 once horizontal flight has been achieved. In achieving horizontal flight, the nose cone 8 is directed downwards; the rear thruster assembly 24 becomes optimally positioned to produce horizontal thrust; the at least one wing 12 becomes optimally positioned to produce a lift force; and the at least one horizontal stabilizer 15 becomes optimally positioned to control the pitch of the zero transition VTOL aircraft. The downward pitch of the nose cone 8 is less, the slower the flight speed of the zero transition VTOL aircraft, while the angle of attack of the at least one wing 12 is greater, the slower the flight speed of the zero transition VTOL aircraft. In some embodiments of the present invention, it is possible for sections of the at least one fuselage 7 to be designed such that they remain level or near level while in forward flight and/or while hovering. The center of gravity 3 of the zero transition VTOL aircraft can also be manipulated according to the positioning of its components in order to change the angle of pitch of the nose cone 8 during both vertical and horizontal flight.

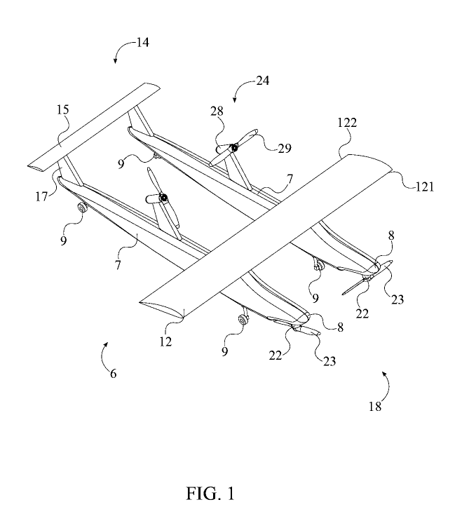

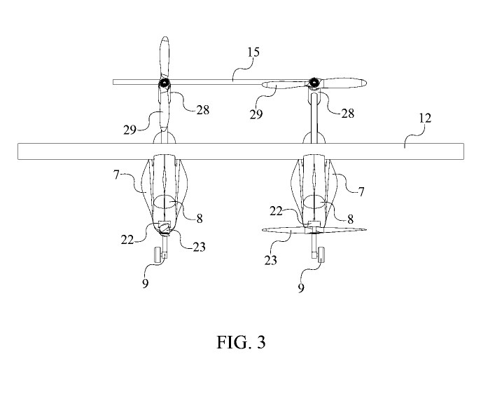

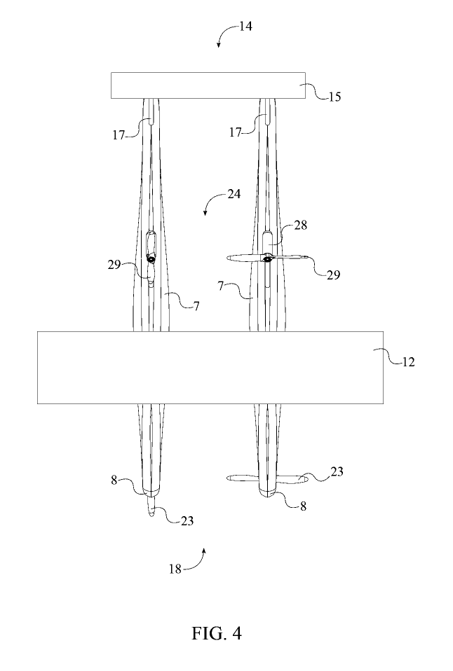

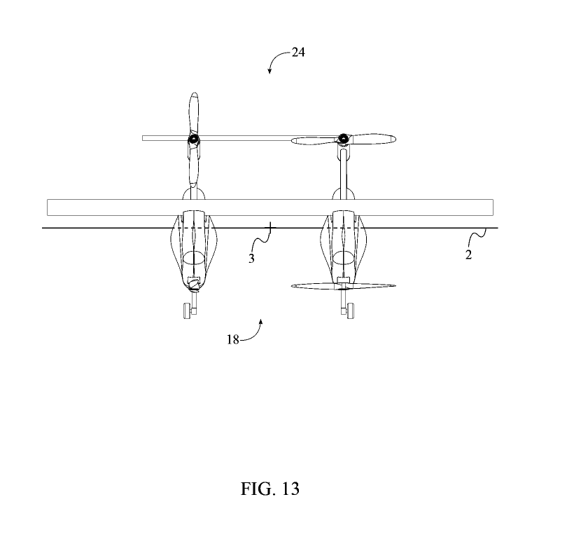

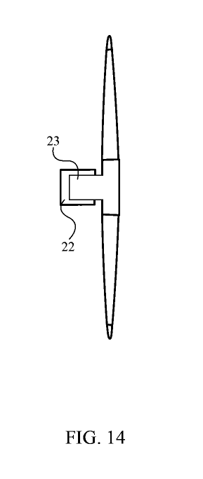

In reference to FIG. 1-4 and FIG. 12-13, the front thruster assembly 18 comprises an at least one front nacelle 22 and an at least one front thruster 23. The at least one front nacelle 22 is adjacently connected to the airframe 6 towards the nose cone 8. In the preferred embodiment of the present invention, the at least one front nacelle 22 is connected to the at least one fuselage 7, however, it is also possible for the at least one front nacelle 22 to be connected to the at least one wing 12. The at least one front thruster 23 provides a variable horizontal thrust and vertical thrust according to the orientation of the zero transition VTOL aircraft. The at least one front thruster 23 is positioned within the at least one front nacelle 22, as shown in FIG. 14. In this way, the at least one front nacelle 22 provides a housing for at least one front thruster 23, as well as a point of connection between the at least one front thruster 23 and the airframe 6. The at least one front thruster 23 can be positioned longitudinally along the at least one front nacelle 22 in either direction so long as downward thrust may be produced. The front thruster assembly 18 is positioned across the front thruster plane 20 and is laterally positioned about the center of gravity 3. In this way, the thrust produced by the front thruster assembly 18 provides lateral stability and yaw control of the zero transition VTOL aircraft.

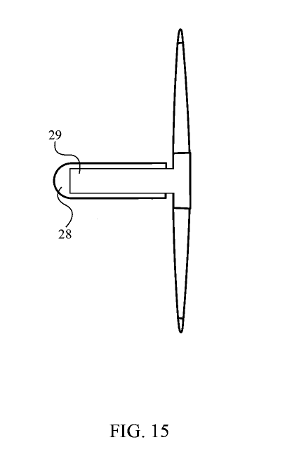

In reference to FIG. 1-4 and FIG. 12-13, the rear thruster assembly 24 comprises an at least one rear nacelle 28 and an at least one rear thruster 29. The at least one rear nacelle 28 is adjacently connected to the airframe 6. In the preferred embodiment of the present invention, the at least one rear nacelle 28 is connected to the at least one fuselage 7, however, it is also possible in other embodiments for the at least one rear nacelle 28 to be connected to the at least one empennage 14. The at least one rear thruster 29 provides a variable horizontal thrust and vertical thrust according to the orientation of the zero transition VTOL aircraft. The at least one rear thruster 29 is positioned within the at least one rear nacelle 28, as shown in FIG. 15. In this way, the at least one rear nacelle 28 provides a housing for at least one rear thruster 29, as well as a point of connection between the at least one rear thruster 29 and the airframe 6. The at least one rear thruster 29 can be positioned longitudinally along the at least one rear nacelle 28 in either direction so long as downward thrust may be produced. The rear thruster assembly 24 is positioned across the rear thruster plane 26 and is laterally positioned about the center of gravity 3. In this way, the thrust produced by the rear thruster assembly 24 provides lateral stability and yaw control of the zero transition VTOL aircraft.

In one embodiment of the present invention, the zero transition VTOL aircraft utilizes tiltrotors, wherein the at least one front nacelle 22 and the at least one rear nacelle 28 are pivotally connected to the airframe 6. The angle of the at least one front nacelle 22 and the at least one rear nacelle 28 can be adjusted before, during or after vertical take-off. In this way, the at least one front thruster 23 and the at least one rear thruster 29 can be repositioned in order to change the direction of the thrust produced. This can be used to achieve optimal flight configurations throughout different phases of flight. As the use of tiltrotors is completely optional, they are never required for the zero transition VTOL aircraft to transition between vertical and forward flight. Additionally, it is possible to include at least one specific purpose thruster, positioned such that it is used only for vertical flight or horizontal flight. The at least one purpose specific thruster can be activated and shut off on an as needed basis. The use of the at least one purpose specific thruster in conjunction with control surfaces, such as elevators, ailerons, and rudders, is beneficial for attitude control when the at least one front thruster assembly 18 and the at least one rear thruster assembly 24 each have specifically one nacelle and one thruster.

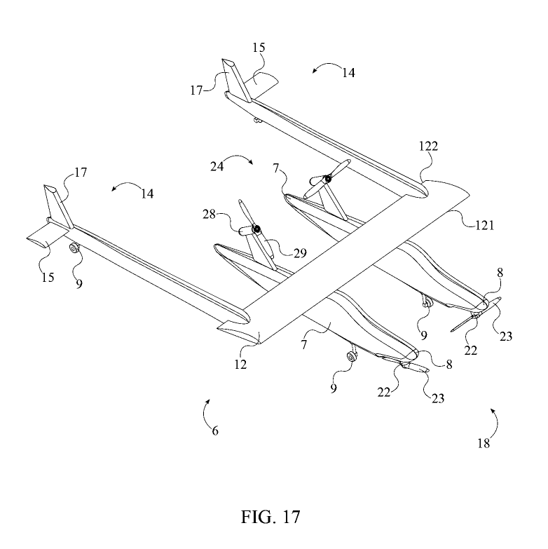

In reference to FIG. 1-4, the at least one empennage 14 is adjacently connected to the at least one fuselage 7 in one embodiment of the present invention, wherein the at least one empennage 14 provides rearward stabilizing surfaces for controlling the pitch and yaw of the zero transition VTOL aircraft. In another embodiment of the present invention, the at least one empennage 14 is adjacently connected to the at least one wing 12, as shown in FIG. 17. In some embodiments of the present invention, the at least one horizontal stabilizer 15 is positioned at a fixed horizontal stabilizer angle in relation to the first plane 4. Similar to the at least one wing 12, each of the at least one horizontal stabilizer 15 may comprise a leading stabilizer edge and a trailing stabilizer edge coincident with a stabilizer chord plane used to position the at least one horizontal stabilizer 15. Alternatively, the at least one horizontal stabilizer 15 may be actively positioned, wherein it may freely adjust to the direction of the relative wind in order to maintain a constant angle of attack. The at least one horizontal stabilizer 15 provides equilibrium, stability and control in relation to the pitch of the zero transition VTOL aircraft. Ideally, the at least one horizontal stabilizer 15 is positioned outside of the prop wash area of both the front thruster assembly 18 and the rear thruster assembly 24. Each of the at least one horizontal stabilizer 15 may also include an elevator, which can be used to control pitch movements. Similar to the at least one horizontal stabilizer 15, it is possible for the elevator to be fixedly positioned or, alternatively, to be actively positioned. The at least one vertical stabilizer 17 is positioned adjacent to the at least one horizontal stabilizer 15 and the rear thruster assembly 24. In this way, the at least one vertical stabilizer 17 extends upwards and provides directional stability to the zero transition VTOL aircraft. The at least one vertical stabilizer 17 may include a rudder, which can be used to control yaw movements.

In reference to FIG. 1-4, the nose cone 8 is positioned opposite of the at least one empennage 14 along the at least one fuselage 7, wherein the nose cone 8 provides a forward aerodynamic surface and is designed to produce minimal drag. The at least one wing 12 is adjacently connected to the at least one fuselage 7 and is positioned in between the nose cone 8 and the at least one empennage 14. The at least one wing 12 provides a lift generating surface as to induce a lift force on the zero transition VTOL aircraft. The at least one wing 12 may include an aileron, which can be used to control roll movements. It is also possible for the at least one wing 12 to be designed as a free wing such that it may constantly adjust to the direction of the relative wind and maintain a constant angle of attack. In some embodiments of the present invention, the at least one wing 12 may be designed such that it is foldable, retractable or removable in order to conform to storage space restrictions.

In reference to FIG. 1-4, the landing gear assembly 9 is adjacently connected to the airframe 6 and is positioned below the airframe 6. The landing gear assembly 9 allows the zero transition VTOL aircraft to perform short or long take-off and landing maneuvers from a runway, body of water, etc. The landing gear assembly can comprise struts, wheels, floats/hulls, or any other type of landing gear. In one embodiment of the present invention, the landing gear assembly 9 comprises a longer landing gear assembly and a shorter landing gear assembly. The longer landing gear assembly is positioned adjacent to the nose cone 8, while the shorter landing gear assembly is positioned adjacent to the at least one empennage 14. In this way, the frontward section of the zero transition VTOL aircraft is raised above the rearward section. This configuration assists in the vertical take-off of the zero transition VTOL aircraft, allowing both the front thruster assembly 18 and the rear thruster assembly 24 to be powered on at the same time. It is also possible for the longer landing gear assembly and the shorter landing gear assembly to be switched in order to provide more room for the rear of the zero transition VTOL aircraft to tilt backwards during vertical take-off.

As an alternative to the landing gear assembly 9, the airframe 6 may be designed such that it has a rearward pivot point positioned behind the center of gravity 3 of the zero transition VTOL aircraft. This is accomplished by positioning the at least one empennage 14 at an empennage angle in relation to either the at least one fuselage 7 or the front plane 4. The empennage angle can be either positive or negative such that the at least one empennage 14 can be directed upwards or downwards. The at least one fuselage 7, which is positioned in front of the pivot point is able to stably rest on the ground when the zero transition VTOL aircraft is not in flight. When the at least one empennage 14 is angled upwards, the pivot point prevents the at least one empennage 14 from contacting the ground while the zero transition VTOL aircraft performs a vertical take-off or landing. Angling the at least one empennage 14 downwards gives the zero transition VTOL aircraft a lower aerodynamic profile while in forward flight.

In reference to FIG. 1-4, in the preferred embodiment of the present invention, both the at least one front nacelle 22 and the at least one rear nacelle 28 have specifically two nacelles and both the at least one front thruster 23 and the at least one rear thruster 29 have specifically two electric motor driven proprotors; thus forming a pair of left thrusters and a pair of right thrusters. Additionally, in the preferred embodiment of the present invention, the at least one fuselage 7 has specifically two fuselages; the at least one wing 12 has specifically one wing; the at least one horizontal stabilizer 15 has specifically one horizontal stabilizer; and the at least one vertical stabilizer 17 has specifically two vertical stabilizers. Each of the at least one front thruster 23 is positioned on the underside of each of the at least one fuselage 7, adjacent to the nose cone 8. Each of the at least one rear thruster 29 is positioned above each of the at least one fuselage 7 in between the at least one wing 12 and the at least one empennage 14. In other embodiments of the present invention, the at least one front thruster 23 and/or the at least one rear thruster 29 may be positioned above, below, or laterally about the at least one fuselage. In the preferred embodiment, all pitch, roll and yaw movements can be controlled using differential thrust, wherein the at least one front thruster 23 overpowers the at least one rear thruster 29 to pitch up and carry out backwards flight; the at least one rear thruster 29 overpowers the at least one front thruster 23 to pitch down and carry out forward flight; the pair of left thrusters overpower the pair of right thrusters to roll right and move right; the pair of right thrusters overpower the pair of left thrusters to roll left and move left; the front right thruster and rear left thruster overpower the front left thruster and the rear right thruster to yaw right; and the front left thruster and rear right thruster overpower the front right thruster and rear left thruster to yaw left. The proprotors are counter-rotating such that the net rotor torque is zero when all thrusters are equally powered. Additionally, the rotational direction of the electric motor driven proprotors can also be designed such that their rotor torque assists in carrying out yaw maneuvers.

In an alternative embodiment of the present invention, both the at least one front nacelle 22 and the at least one rear nacelle 28 have specifically one nacelle and both the at least one front thruster 23 and the at least one rear thruster 29 have specifically two proprotors. In this way both the front thruster assembly and the rear thruster assembly comprise a single nacelle which houses two coaxial proprotors. The two coaxial proprotors of each nacelle may be counter-rotating as to provide precise and stable yaw and pitch control in forward flight in addition to forward and backward movement while in the hover position. Additionally, it is possible for the thrusters to feature variable pitch blades in this embodiment. The concept of coaxial proprotors can also be applied to other embodiments of the present invention, wherein the at least one front nacelle 22 and the at least one rear nacelle 28 have more than one nacelle. The use of multiple coaxial proprotors or otherwise redundant thrusters provides a failsafe in the event that a single thruster fails.

It is also possible for both the at least one front thruster 23 and the at least one rear thruster 29 to be any other type of thrust producing device such as an engine driven propeller, turboprop, turboshaft driven propeller or jet engine. The at least one front thruster 23 and/or the at least one rear thruster 29 may be powered individually or centrally from a common power source. If the at least one front thruster 23 and at least one rear thruster 29 include propellers, then the following additional features can be employed by the zero transition VTOL aircraft. Each of the propellers can be driven by a stepper motor or similar device, wherein the propellers can be shut off such that they are positioned parallel to or otherwise in line with the at least one fuselage 7. This can be used to assist in the aerodynamics of the zero transition VTOL aircraft when particular thrusters are not needed for flight. Propellers may also be designed such that they have variable pitch blades, wherein the pitch of the blades can be adjusted to produce reverse thrust without changing the direction of the propeller shaft revolutions. Alternatively, the direction of the propeller shaft revolutions may be reversed in order to produce reverse thrust. It is also possible for propellers to use cyclic pitch in order to control the direction in which thrust is produced. When electrically driven propellers are used it is possible for a capacitor to be electrically connected to all thrusters or individual thrusters. The capacitor holds an electrical charge which can be released to provide a burst of power to the connected thrusters.

In one embodiment of the present invention, the at least one front nacelle 22 and the at least one rear nacelle 28 further comprise a plurality of vanes. The plurality of vanes is attached across the at least one front nacelle 22 and the at least one rear nacelle 28. Each of the plurality of vanes is positioned within the exit flow of the at least one front thruster 23 or the at least one rear thruster 29 and can be adjustably angled as to change the direction of the exit flow. In this way, the direction of the produced thrust can be changed according to the position of the plurality of vanes in order to control the attitude of the aircraft. The plurality of vanes may be utilized with any type of thrusters.

In an unmanned aerial vehicle (UAV) embodiment of the present invention, the zero transition VTOL aircraft may have a variety of additional features. In a typical UAV embodiment, the at least one front thruster 23 and the at least one rear thruster 29 are proprotors driven by electric motors. A battery power source supplies power to the electric motors, as well as other onboard electronic systems used for controlling the zero transition VTOL aircraft. In turn, the length of flight missions is limited to the charge that can be retained by the battery. In order to address this issue, the zero transition VTOL aircraft can be equipped with solar panels. Ideally the solar panels are positioned long the top of the at least one wing 12, however, it is possible for the solar panels to be anywhere along the top of the airframe 6. The solar panels are electrically connected to the battery power source and can be used to charge the battery source while the zero transition VTOL aircraft is in flight or in a grounded position. It is also possible to utilize the movement of the proprotors to recharge the battery power source under certain circumstances. In the event that the battery power source charge is depleted during a flight mission, the zero transition VTOL aircraft may still coast through the air. This movement through the air can act to spin the proprotors. This wind energy can then be harnessed to provide enough charge to the battery power source such that the zero transition VTOL aircraft can be controlled in order to attempt a regulated landing. Similarly, using the same concept, wind energy can be harnessed by the proprotors and used to charge the battery power source while the zero transition VTOL aircraft is at rest on the ground.

In a UAV embodiment, the zero transition VTOL aircraft may also be designed such that it is more readily stored and carried. This can be accomplished by allowing any of the at least one fuselage 7, at least one wing 12, at least one empennage 14, front thruster assembly 18 or rear thruster assembly 24 to be dismantled, folded or otherwise made more compact. This is especially useful for reconnaissance or surveillance missions when the zero transition VTOL aircraft is equipped with a camera or other imaging device. For example, this would allow a team of soldiers to carry the zero transition VTOL aircraft with them on missions and use the zero transition VTOL aircraft to carry out reconnaissance from remote locations.

In a roadable embodiment of the present invention, the zero transition VTOL aircraft is designed such that it may also be driven on the ground. Similar to the UAV embodiment, the at least one fuselage 7, at least one wing 12, at least one empennage 14, front thruster assembly 18 and/or rear thruster assembly 24 may be designed such that it can be dismantled, folded or otherwise made more compact. The landing gear assembly 9 can function as a set of controllable wheels or a set of controllable wheels can be provided in addition to the landing gear assembly 9. Additionally a steering wheel is provided for operating the controllable wheels while driving.

In a submersible embodiment of the present invention, the zero transition VTOL aircraft is designed such that it may also be operated under water. The front thruster assembly 18 and the rear thruster assembly 24 are used to propel and navigate the zero transition VTOL aircraft through the water. Control surfaces on the at least one wing 12 and at least one empennage 14 may also assist in controlling the zero transition VTOL aircraft while underwater.

Although the invention has been explained in relation to its preferred embodiment, it is to be understood that many other possible modifications and variations can be made without departing from the spirit and scope of the invention as hereinafter claimed.

1. A zero transition vertical take-off and landing (VTOL) aircraft comprises:
an airframe;
a front thruster assembly;
a rear thruster assembly;
the airframe comprises an at least one wing;
each of the at least one wing comprises a leading wing edge and a trailing wing edge;
a center of gravity;
a longitudinal axis traversing through the center of gravity;
a lateral axis traversing through the center of gravity and being perpendicular to the longitudinal axis;
a first plane being coincident with the longitudinal axis and the lateral axis;
a wing intersection axis, a front intersection axis, and a rear intersection axis being parallel to the lateral axis;
a wing chord plane being coincident with the leading wing edge and the trailing wing edge;
the wing chord plane being coincident with the first plane along the wing intersection axis;
a rear thruster plane being coincident with the wing chord plane along the rear intersection axis;
the rear thruster assembly being positioned normal to the rear thruster plane, wherein the rear thruster assembly produces thrust normal to the rear thruster plane;
a front thruster plane being coincident with the rear thruster plane along the front intersection axis;
the front thruster assembly being positioned normal to the front thruster plane, wherein the front thruster assembly produces thrust normal to the front thruster plane;
the front thruster assembly being positioned adjacent to the center of gravity along the longitudinal axis; and
the rear thruster assembly being positioned adjacent to the center of gravity along the longitudinal axis and opposite to the front thruster assembly.

2. The zero transition VTOL aircraft as claimed in claim 1 comprises:
the wing chord plane and the first plane being positioned at a wing angle;
the wing angle traversing from the first plane to the wing chord plane;
the rear thruster plane and the wing chord plane being positioned at a rear thruster angle;
the rear thruster angle traversing from the wing chord plane to the rear thruster plane;
the front thruster plane and the rear thruster plane being positioned at a front thruster angle; and
the front thruster angle traversing from the rear thruster plane to the front thruster plane.

3. The zero transition VTOL aircraft as claimed in claim 2 comprises:
the wing angle being a positive angle between 0 degrees and 45 degrees;
the rear thruster angle being a positive angle between 80 degrees and 130 degrees; and
the front thruster angle being a negative angle between 90 degrees and 150 degrees.

4. The zero transition VTOL aircraft as claimed in claim 1 comprises:
the front thruster assembly being positioned across the front thruster plane and laterally positioned about the center of gravity, wherein the front thruster assembly provides lateral stability and yaw control;
the front thruster assembly comprises an at least one front nacelle and an at least one front thruster;
the at least one front thruster being positioned within the at least one front nacelle; and
the at least one front nacelle being adjacently connected to the airframe.

5. The zero transition VTOL aircraft as claimed in claim 1 comprises:
the rear thruster assembly being positioned across the rear thruster plane and laterally positioned about the center of gravity, wherein the rear thruster assembly provides lateral stability and yaw control;
the rear thruster assembly comprises an at least one rear nacelle and an at least one rear thruster;
the at least one rear thruster being positioned within the at least one rear nacelle; and
the at least one rear nacelle being adjacently connected to the airframe.

6. (canceled)

7. (canceled)

8. (canceled)

9. (canceled)

10. The zero transition VTOL aircraft as claimed in claim 1 comprises:
the airframe further comprises a landing gear assembly;
the landing gear assembly being adjacently connected along the airframe; and
the landing gear assembly being positioned below the airframe.

11. (canceled)

12. (canceled)

13. (canceled)

14. (canceled)

15. (canceled)

16. (canceled)

17. (canceled)

18. (canceled)

19. (canceled)

20. The zero transition VTOL aircraft as claimed in claim 5 comprises:
the at least one rear nacelle being pivotally connected to the airframe.

21. The zero transition VTOL aircraft as claimed in claim 1 comprises:
the airframe further comprises an at least one empennage.

22. The zero transition VTOL aircraft as claimed in claim 21 comprises:
the at least one empennage being adjacently connected to the at least one wing.

23. The zero transition VTOL aircraft as claimed in claim 21 comprises:
the at least one empennage comprises an at least one horizontal stabilizer.

24. The zero transition VTOL aircraft as claimed in claim 21 comprises:
the at least one empennage comprises an at least one vertical stabilizer.

25. The zero transition VTOL aircraft as claimed in claim 21 comprises:
the at least one empennage comprises an at least one horizontal stabilizer and an at least one vertical stabilizer; and
the at least one vertical stabilizer being positioned adjacent to the at least one horizontal stabilizer and the rear thruster assembly.

26. The zero transition VTOL aircraft as claimed in claim 1 comprises:
the airframe further comprises an at least one fuselage; and
each of the at least one fuselage comprises a nose cone.

27. The zero transition VTOL aircraft as claimed in claim 26 comprises:
the at least one front nacelle being positioned adjacent to the nose cone.

28. The zero transition VTOL aircraft as claimed in claim 26 comprises:
the at least one wing being adjacently connected to the at least one fuselage; and
the leading wing edge and the trailing wing edge being positioned opposite of each other across the at least one wing.

29. The zero transition VTOL aircraft as claimed in claim 28 comprises:
the airframe further comprises an at least one empennage;
the at least one empennage being adjacently connected to the at least one fuselage;
the at least one empennage being positioned opposite of the nose cone along the at least one fuselage; and
the at least one wing being positioned in between the nose cone and the at least one empennage.
